(19) United States
(12) Patent Application Publication
(10) Pub. No.: US 2008/0010519 A1
(43) Pub. Date: Jan. 10, 2008

(54) Front panel wizard for extracting historical event information

(75) Inventor: Matthew D. Beyer, Broomfield, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/476,313

(22) Filed: Jun. 27, 2006

(51) Int. Cl. G06F 11/00

(52) U.S. Cl. 714/21

(57) ABSTRACT

A media drive having a front panel for displaying historical event information associated with the media drive is provided. The media drive includes a front panel portion having a plurality of indicia for displaying information in a binary format. In one example, the indicia include a plurality of light emitting diodes (or other light sources) for representing the binary data. The media drive further includes a drive controller having display logic for selectively addressing the plurality of indicia to display historical event information associated with the media drive. The historical event information may include historical events (e.g., types or categories of historical events) as well as detailed error codes associated with the historical events (e.g., more detailed information relating to the status or error of the particular historical event).

### BACKGROUND

1. Field

The present invention relates generally to data storage systems, and in one example, to a system and method for extracting historical event information from a data storage system via a front panel portion thereof.

2. Related Art

Advances in embedded controller technology have enabled computer mass storage devices having embedded controllers to include self-contained test, adaptation, upgrade, and diagnostics capabilities. For example, modern streaming linear tape drives, such as currently available DLT™ tape drive products are often equipped to perform comprehensive tests, and such drives may further store a large amount of information about failure modes and applicable commands, and maintain such information even during a power failure.

Diagnostic routines are typically carried out via communications over the main bus structure interconnecting the storage device with a host computer, such as a Small Computer System Interface (SCSI) bus. While testing over the primary bus is practical so long as the interface remains functional, the primary bus interface structure remains the only direct access to the embedded controller. Some error or diagnostic conditions make use of the primary bus structure impractical. Also, after the drive has been installed in a computer system, such as a PC server, diagnosis of fault conditions possibly involving the drive typically require entry into the computer housing, and frequently the removal of the drive for separate testing and handling. As drives are being made to store ever-increasing amounts of user data, the drives have become more sensitive to handling during installation and removal. Thus, minimizing handling of drives after installation into a computer is generally desirable in order to minimize damage.

Present state-of-the-art tape drives and other mass storage devices frequently make use of a variety of port expanders, serial ports, and special command sets over the SCSI bus primary interface in order to provide input and output for testing and problem diagnosis during the design, validation, and manufacturing processes. One example of a secondary port useful for data exchange includes the use of a secondary serial port and communications path provided from the micro-controller to a “dumb” terminal. Results of a diagnostic monitor routine executed by the micro-controller were communicated via the serial port to the dumb terminal and displayed thereon for later analysis and/or corrective action by the design/manufacturing team. In addition, the secondary serial port enabled diagnostic routines to be downloaded from an external computer to the disk drive, stored in a random access memory chip on board the drive and later executed by the drive's embedded micro-controller. The serial port was typically accessed by a secondary jack or edge connector formed on a printed circuit board carrying the drive circuitry, but not conveniently available once the drive was installed within a computer cabinet or housing.

While the additional port capability is useful within the drive design, checkout and manufacturing operations, this capability is not generally available at the user/customer site. For example, the secondary connector was generally inaccessible after the drive was installed into a computer cabinet, such as a personal computer, and was accessible only after first removing the drive from the computer housing and/or by disturbing the computer's wiring.

Most mass storage devices present a front panel appearance within the computer housing. This is particularly true of digital tape drives, and disk drives servicing removable media. Media drives are also frequently provided with a panel bezel which is presented as part of the front panel of the computer. A drive activity light-emitting diode (LED) is most frequently included in the front panel bezel, in order to provide a visual indication of present drive activity during computer operations, e.g., busy or idle.

It is further known to communicate to a mass storage device via a wireless data path through the front panel of the device and/or after the device has been installed in a computer without disturbing the computer cabling and the like, as described, for example, in U.S. Pat. No. 5,894,425. The ability of the drive to communicate via a wireless data path, however, generally increases the cost and complexity of the drive. For example, the drive may require additional components to transmit wirelessly and the user to have a corresponding device.

Therefore, it is generally desired to be able to diagnose errors and access historical event information from the front panel of the storage device. For example, extracting error and historical event information via a front panel of the device after the device has been installed in a computer housing or cabinet, computer rack, or the like. Further, it is generally desired to diagnose errors and manage such errors with reduced cost and complexity in the form of additional features, connectors, panels, and the like.

### BRIEF SUMMARY

In accordance with one aspect of the present invention, a media drive having a front panel for displaying historical event information associated with the media drive is described. In one example, the media drive includes a front panel portion having a plurality of indicia for displaying information in a binary format. In one example, the indicia include a plurality of light emitting diodes (or other light sources) for representing binary data (e.g., 1's and 0's). The media drive further includes a drive controller having display logic for selectively addressing the plurality of indicia to display historical event information associated with the media drive.

In one example the historical event information includes at least two historical events (e.g., categories or types of historical events), which are displayed in sequential order via the plurality of indicia. The historical events may be displayed in response to user input, e.g., in response to a selection of the unload button. The historical event information may further include at least one detailed information error code (including status or error codes) associated with at least one of the historical events, e.g., the most recent event. Additionally, a predetermined pattern or act (e.g., rapidly flashing lights or sound(s)) may be interposed between the historical events and the detailed information error code to indicate to a user that detailed information error code is being displayed.

In accordance with another aspect of the invention, a method for extracting historical event information from a media drive is provided. In one example, the method includes displaying information associated with at least two historical events related to the media drive, wherein the information is displayed via a front panel portion of the media drive in a binary format. The historical event information may be extracted in response to user input, for example, in response to selection of an unload button associated with the drive. The information may be displayed via a plurality of indicia such as LEDs or other suitable indicia. Additionally, the historical event information may include event types (or categories) as well as detailed information error or status codes.

In accordance with another aspect of the invention, a computer program product comprising program instructions for extracting historical event information from a media drive is provided. In one example, the product comprises program code for addressing a plurality of indicia to display information associated with at least two historical events related to a media drive. Further, the information is displayed in a binary format and the indicia are associated with a front panel portion of the media drive.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 illustrates an exemplary data storage system.

FIG. 2 illustrates a perspective view of an exemplary media drive having a plurality of indicia on the front panel for extracting historical event information.

FIG. 3 illustrates an exemplary sequence of displaying historical event information via a front panel of a media drive.

FIG. 4 illustrates an exemplary method for retrieving and displaying historical even information via a front panel of a media drive.

FIGS. 5A and 5B illustrate exemplary devices including a media drive storage system as described.

In the following description, reference is made to the accompanying drawings which form a part thereof, and which illustrate various examples of the present invention. It is understood that other examples may be utilized and structural and operational changes may be made without departing from the scope of the present invention.

### DETAILED DESCRIPTION

The following description is presented to enable a person of ordinary skill in the art to make and use the various aspects of the present invention. Descriptions of specific structures, functions, techniques, and applications are provided only as examples. Various modifications to the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the scope consistent with the appended claims.

Some portions of the detailed description which follows are presented in terms of procedures, steps, logic blocks, processing, and other symbolic representations of operations on data bits that can be performed on computer memory. A procedure, computer executed step, logic block, process, etc., are here conceived to be a self-consistent sequence of steps or instructions leading to a desired result. The steps are those utilizing physical manipulations of physical quantities. These quantities can take the form of electrical or magnetic signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

In one example described herein, a storage media drive includes a front panel portion having a number of indicia, e.g., 2-8 LEDs, which are used to display historical event information associated with the media drive. The media drive controller generally stores or may access historical information of significant events (e.g., failures to read/write, load etc.), which may be categorized by an event type (e.g., a SCSI error, servo fault, or the like) and a detailed information status or error code (e.g., more detailed information of the event type specific to the particular event). The media drive controller further includes logic for addressing the indicia to display the historical event information.

In one example, 4 indicia (e.g., 4 LEDs or the like) are included to display 4 bits, or a nibble, of information. The controller selectively addresses the indicia to scroll through two or more historical events as well as display detailed information relating to one or more of the historical events (e.g., the indicia may display information associated with types of historical events as well as more detailed information of individual historical events). The binary information displayed via the indicia may be decoded by a user or user device to determine the historical event information (e.g., the type of historical event and/or detailed information relating thereto).

In this fashion, historical event information may be obtained from the front panel of the storage device without, e.g., removing the drive from a support structure or disturbing associated cabling. Further, such a system may extract historical event information at relatively low cost and complexity to the storage device. For example, such a system and method may reduce the cost of a media drive by reducing the number and complexity of interfaces (which generally limit the ability to extract failure and status information from the media drive). Additionally or alternatively, if a primary data interface associated with the media drive, e.g., a standard graphical user interface for displaying text or the like, is not functioning, a system having indicia as described may provide a manner in which to extract information from the drive. The exemplary system and method for extracting information from the drive may also reduce or prevent a host server from being interrupted because the extraction of information is via the front panel of the drive and may not require disturbing the media drive or computer system operation.

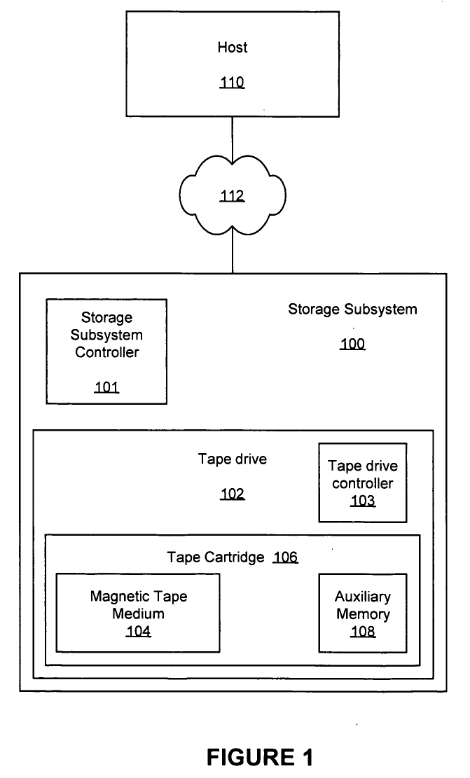

Storage systems for use with removable media, such as magnetic tape or disc drives, optical tape or disc drives, and the like, are widely used for storing information in digital form. With reference initially to FIG. 1, an exemplary storage susbsystem 100 including a magnetic tape drive 102 and removable magnetic tape cartridge 106, is described. Storage subsystem 100 may include, e.g., a PC server, server class machine, mainframe, desktop computer, or the like. Storage subsystems 100 may include a storage subsystem controller 101 for controlling one or more tape drives 102 contained within the storage subsystem 100 and for controlling other components of the storage subsystem 100.

The storage subsystem 100 may be coupled to a host system 110, which transmits I/O requests to the storage subsystem 100 via a host/storage connection 112. The host system 110 may comprise any computational device known in the art including, for example, a server class machine, a mainframe, a desktop computer, a laptop computer, a hand held computer, or a telephony device.

Tape drive 102 reads and writes data to the primary storage medium, shown in FIG. 1 as a magnetic tape medium 104 contained within a removable magnetic tape cartridge 106. The magnetic tape medium 104 typically comprises a thin film of magnetic material, which stores the data. The tape medium 104 may be moved by tape drive 102 between a pair of spaced apart reels and past a data transducer to record or read back information. In one type of tape drive system, one of the reels is part of the tape drive 102 while the other reel is part of the removable tape cartridge 106. For this type of tape drive system, the reel which is a part of the tape drive 102 is commonly referred to as a take-up reel, while the reel which is a part of the tape cartridge 106 is commonly referred to as a cartridge reel. Upon insertion of the tape cartridge 106 into the tape drive 102, the magnetic tape medium 104 on the cartridge reel is coupled to the take-up reel of the tape drive 102. Subsequently, prior to removing the tape cartridge 106 from the tape drive 102, the storage tape 104 is rewound onto the cartridge reel and is then uncoupled from the take-up reel.

Tape drive 102 further includes a tape drive controller 103 for controlling, at least in part, data transfer operations. Tape drive controller 103 may further include or access a tape drive memory, which may analyze and/or store historical event information. Further tape drive controller 103 may include or access logic for addressing indicia associated with a front panel portion of the tape drive 103 and displaying the historical event information to a user, as described in greater detail below.

In some tape storage subsystems, the removable tape cartridge 106 is provided with a non-volatile auxiliary memory 108 for storing data in a separate storage medium from the primary storage medium. This data is separate from and in addition to the data stored on the primary storage medium. This auxiliary memory 108 can be, for example, a solid state non-volatile memory such as an electrically erasable programmable read-only memory (EEPROM) or a flash memory which is contained in the housing for the tape cartridge 106. Auxiliary memory 108 may further store historical event information accessible by drive 102 and/or storage subsystem 100.

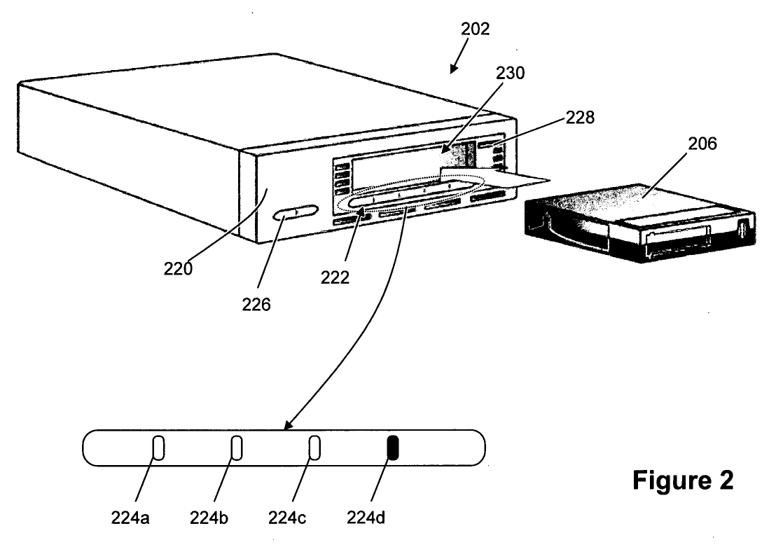

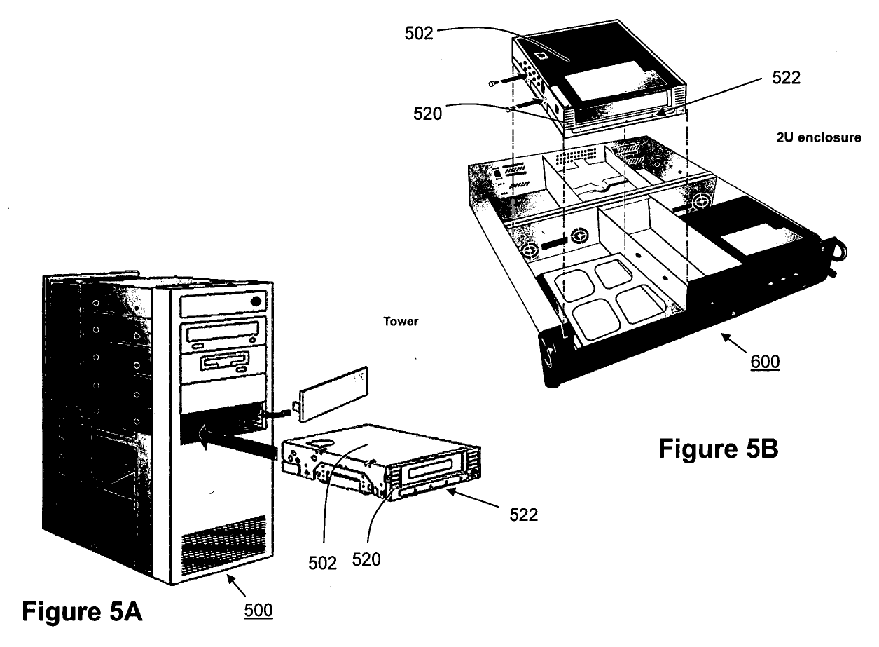

FIG. 2 illustrates a perspective view of an exemplary media drive 202 and removable storage cartridge 206. Media drive 202 generally includes a front panel portion 220 which is exposed to a user when supported or housed in another structure. For example, media drive 202 may be supported or housed in a computer housing or cabinet, computer rack, or the like (see, for example, FIGS. 5A and 5B) in a fashion such that front panel portion 220 is accessible or viewable by a user. Front panel portion 220 generally includes a receiver 230 for receiving a storage cartridge 206, which may include suitable media for media drive 202, and an unload button 228 for ejecting or removing storage cartridge 206 therefrom. Additionally, front panel portion 220 may include a status indicator light 226, e.g., indicating the present status of the drive as idle, busy, or the like.

Front panel portion 220 includes a plurality of indicia 222 in this example, which may include a row of Light Emitting Diodes (LEDs) or other suitable indicia for displaying information in a binary format. Indicia 222 include four LEDs 224a-224d in this example, but any plurality of individual indicium, e.g. two or more, are contemplated. Indicia 222 need not be disposed in a horizontal row, as shown, and may be disposed in other fashions, for example, in a vertical row, square pattern, circular pattern, or combinations thereof. Further, LEDs 224a-d are illustrative of one example of suitable indicia for conveying historical event information. In other examples, indicia may include any identifiable indicia, e.g., other types of light sources, mechanical flags, or the like suitable to display information in binary format.

Media drive 202 further includes a controller and associated memory (not shown, but see, for example FIG. 1) for storing and accessing historical event information associated with media drive 202. In particular, a front panel wizard (e.g., a program to guide user's access to the historical event information) in the form of software, firmware, hardware, or combination thereof associated with media drive 202 operates to extract the historical event information and display the information to a user via indicia 222 of front panel portion 220. For example, the media drive controller may include logic for accessing and displaying the historical event information via the indicia 222.

In one example, the historical event information is retrieved and displayed in chronological order via indicia 222 in response to user input. Each historical event may include a general historical event type or category (e.g., SCSI error, invalid cartridge, etc.) and a detailed informational error or status code (sometimes referred to herein simply as an “error code”). The detailed informational error or status code may be detailed and unique for the conditions of the particular event type and media drive. For example, a historical event type displayed via indicia 222 may correspond to a SCSI error, and the detailed information status or error code displayed via indicia 222 may correspond to a parity error detected on SCSI bus data transfer from host to device. Thus, the detailed error code may provide additional information of the historical event type and may allow a user to pinpoint the failure mode etc.

In one example, the historical event type may be stored and displayed as 4 bits of information (e.g., a nibble), and the detailed information status or error codes stored and displayed as 32 bits of information. Accordingly, in the present example, employing four indicia (e.g., LEDs 224a-224d), an event type may be displayed with a single set of the indicia, i.e., each indicia corresponding to one bit of the information. The 32 bit detailed information status or error code, however, is displayed using 8 sequentially displayed sets of the indicia, e.g., displaying four bits at a time. In one example, in and effort to keep the amount of information presented via the front panel portion 220 manageable, the media drive is operable to display the last 6 event types via indicia 222 as well as the detailed information status or error code of the most recent event type. Of course, the number of event types and detailed information status or error codes may be varied.

In this example, including LEDs 224a-224d, a lighted LED may indicate a binary ‘1’ and an unlighted, or off LED, may indicate a binary ‘0’. The binary data gathered from the front panel may be decoded or interpreted by hand, or entered into a corresponding device or instrument operable to convert the binary data and compare against a dictionary of codes (specific to the media drive product, for example). The binary data may be used directly or converted to hexadecimal values to interpret the information.

In one example, a PC based tool may automatically look-up the binary (or hexadecimal values) in appropriate tables, and present the descriptive definitions of the information, e.g., the most recent event types and the detailed definition of the most recent informational error code. Such a system may provide the user with the ability to extract detailed information from the drive without dependence of host based tools or complex interfaces.

In one example, drive 202 is put into a front panel wizard mode for extracting historical event information in response to user input. For example, a user may press and hold the unload button 228 to initiate the front panel wizard mode and begin extracting historical event information. Of course, other buttons, whether dedicated for historical event information or multiuse, may be used. In one example, the button may be held for a predetermined amount of time, e.g., between 12 and 15 seconds, to initiate the front panel wizard mode. Thereafter, the media drive 202, e.g., the controller, enters the front panel wizard mode and presents historical event information via indicia 222 of front panel portion 220.

In one example, the front panel wizard mode is operable to display a number of historical event types first, followed by at least one detailed information status or error code. The first event category is displayed via LEDs 224a-224d as a binary nibble. In this example, up to 16 different combinations associated with different event categories may be displayed. LEDs 224a-224d may continue to indicate the information until unload button 228 is pressed again, thus acting as a scroll button to scroll through the various event types. For example, as the unload button is successively pressed media drive 202 displays successive event types associated with media drive 202, the event types displayed chronologically, the most recent event types first and so on.

When the recent event types for display have been successively displayed, indicia 222, e.g., LEDs 224a-224d, may display information associated with a detailed information status or error code of the most recent event type. Further, a predetermined pattern may be displayed to indicate a transition from historical event types to detailed information status or error codes; for example, LEDs 224a-224d may flash rapidly after the available recent event types have been displayed to indicate to the user that the next set of information displayed includes a detailed status code related to one of the historical event types. Of course, other methods of indicating a difference between event types and detailed information status codes are possible, including displaying a known pattern, a sound, or the like, as well as no indication at all.

Generally, the detailed information status codes will include more bits than the event types, and in one example, the detailed status codes are represented by 32 bit codes. In this example, wherein 4 bits are presented at a time via indicia 222, the 32 bit code is displayed as a sequence of 8 patterns of information. As stated, the unload button 228 (or other suitable button) may be used to scroll through the 8 patterns to display and extract the entire 32 bit code. In other examples, of course, the detailed status code may include other number bit codes, and may be displayed with fewer or additional patterns.

It should be noted that the use of unload button 228 to initiate a front panel wizard mode and to scroll through information via the front panel is illustrative of one example. In some examples, the front panel wizard may be launched by a first button and scrolling achieved by a second button. Further, first and second scroll buttons (whether dedicated to scrolling or not) might be employed to scroll forward or backward through historical event information. In other examples, the controller may address the indicia to scroll through historical event information automatically at a predetermined period such that a user, or user device, has sufficient time to note the patterns.

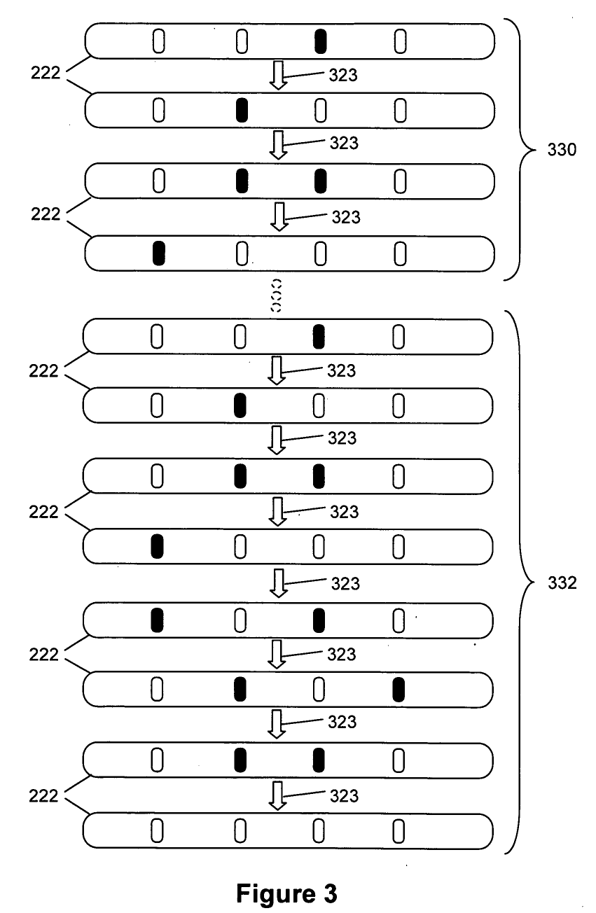

FIG. 3 illustrates an exemplary sequence of displayed historical event information via indicia 222 of a media drive front panel (for example, as shown in FIG. 2). The indicia 222 are shown displaying successive patterns, which may be in response to successive scrolling functions as indicated by arrows 323. The scrolling functions may be in response to user input, e.g., in response to user selection of the unload button, or based on a timing pattern after the front panel wizard mode is initiated as previously described. Similar to above, indicia 222 are used to display historical event information, such as event categories and/or detailed status or error codes via the front panel of a media drive

The first sets of indicia 222 displayed, indicated collectively as 330, may display information associated with the most recent “n” number of event types or categories associated with the particular media drive. The unload button, for example, may be used as a scroll button to view the most recent event types, thereby extracting the historical event information. A user may compare the information, e.g., the 4 bit codes, to a look-up table to determine the meaning of the displayed event types as previously described. Exemplary codes may correspond to various drive or cartridge events such as a general error, SCSI event, software error, permanent write error, permanent read error, servo fault, illegal format, invalid cartridge, calibration failure, cleaning complete, directory read/write failure, diagnostic failure, and so on.

In this example, after the historical event type codes are displayed, as shown by 330, indicia 222 may display detailed status or error codes of one or more of the recent event type codes. For example, a detailed error code of the most recent event may be displayed as a sequential set of indicia 222, indicated collectively as 332. It is noted that in one example, the detailed information status or error code is a 32 bit code, and therefore includes 8 patterns of indicia 222 (although any number of patterns and length of the detailed information status or error code bits are contemplated). Further, in one example, the indicia 222 flash rapidly after the last available event code displayed in 330 to indicate to a user that the pattern(s) following the indication include a detailed information status or error code associated, e.g., with the most recent event code.

Various modifications will be apparent to those of ordinary skill in the art. For example, indicia 222 may be operable to display any number of event type codes 330 followed by any number of detailed information status or error codes 332. Further, event type codes 330 may be interleaved with detailed information status or error codes 332; for example, detailed information status or error codes following each displayed event type code.

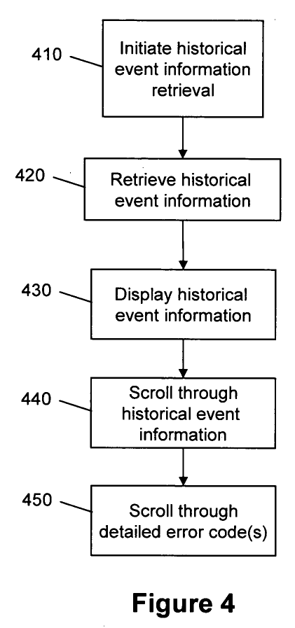

FIG. 4 illustrates an exemplary method for retrieving and displaying historical event information associated with a media drive. In one example, the media drive (e.g., the controller) includes logic for carrying out the exemplary methods. Initially, a front panel wizard mode is initiated at 410, whereby a user may extract historical event information stored with or accessible by the media drive. The front panel mode may be initiated by the media drive or a computer host in response to user input, e.g., selecting a button such as the unload button. Additionally or alternatively, the front panel mode may be initiated by the media drive itself, e.g., in response to an event such as a load or unload of a cartridge, power-up (or down) of the media drive, periodic diagnostic check, signal from a host computer, or the like.

The media drive retrieves the historical event information (including historical event types or categories and/or detailed information error or status codes) at 420. The historical event information may be stored with a memory portion of the media drive (e.g., in non-volatile memory of the media drive) and accessed or retrieved by the media drive controller. Alternatively or additionally, at least a portion of the historical event information may be stored remotely to the media drive, e.g., with a host, subsystem supporting the media drive, or a removable storage cartridge. In such a case, the drive controller may retrieve the historical event information into local memory or access the information as needed to carry out the front panel wizard functions.

The media drive initiates the display of at least a portion of the historical event information retrieved at 430. For example, the drive controller may address indicia associated with a front panel portion of the drive to display the most recent historical event code, which may be decoded by a user. The information may be displayed in a binary format via any suitable indicia associated with the media drive, and in particular the front panel portion of the media drive.

The media drive controller may further operate to scroll through (or otherwise sequentially display) separate historical event codes at 440. In one example, the information is scrolled through in response to user input, e.g., pressing and releasing buttons. Alternatively, the drive may scroll through the information at a predetermined period, e.g., every few seconds or the like.

In one example, the historical event information further includes detailed informational status or error codes associated with at least one of the historical events retrieved and displayed. Accordingly, at 450, a detailed information status or error code is displayed and may be scrolled through in response to user input. As described previously, the detailed information status or error code may include multiple patterns of the indicia and may correspond to the most recent historical event information.

FIGS. 5A and 5B illustrate exemplary devices including a media drive storage system having a front panel wizard as described herein. In particular, FIG. 5A illustrates a computer cabinet or tower 500 for supporting and housing a media drive 502. Computer tower 500 may generally house a PC server, for example. Generally, with media drive 502 disposed within computer tower 500, front panel portion 520 and indicia 522 are accessible and visible to a user. Accordingly, indicia 522 may display historical event information of media drive 502 to a user without removing portions of media drive 502, computer tower 500, or otherwise disturbing cabling or other components housed with computer tower 500.

FIG. 5B illustrates a rack mount 600 for supporting media drive 502. As is well known in the art, racks such as rack mount 600 may be stacked vertically and supported by a frame (not shown). Generally, with media drive 502 mounted and stacked with rack mount 600 in such a fashion, front panel portion 520 of media drive 502 is accessible and viewable to a user. Similar to the example of FIG. 5A, indicia 522 therefore may display historical event information of media drive 502 to a user without removing drive 502 from the housing of rack 600 or otherwise disturbing the cabling or other components of rack mount 600 or neighboring components mounted therewith.

The foregoing description of the preferred embodiments of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto. The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A media drive for use with removable storage devices, the media drive comprising:
a front panel portion having a plurality of indicia for displaying information in a binary format; and
a drive controller, the drive controller accessing display logic for addressing the plurality of indicia to display historical event information associated with the media drive.

2. The storage system of claim 1, wherein the historical event information includes at least two historical events, the display logic for displaying the information for each historical event sequentially via the plurality of indicia.

3. The storage system of claim 2, wherein the display logic displays the historical events in sequential order in response to user input.

4. The storage system of claim 2, wherein the display logic displays the historical events in response to selection of the unload button.

5. The storage system of claim 1, wherein the controller includes logic for storing a plurality of historical events and at least one detailed error code, the detailed error code associated with at least one of the historical events.

6. The storage system of claim 5, wherein the display logic is operable to address the indicia to display the plurality of historical events in sequential order followed by the at least one detailed error code.

7. The storage system of claim 5, wherein the display logic further addresses the indicia to display a predetermined pattern interposed between at least one of the historical events and the at least one detailed error code.

8. The storage system of claim 1, wherein the indicia include light emitting diodes.

9. A method for extracting historical event information from a media drive, the method comprising:
displaying information associated with at least two historical events related to a media drive, wherein the information is displayed via a front panel portion of the media drive in a binary format.

10. The method of claim 9, further comprising displaying the historical events in sequential order.

11. The method of claim 9, further comprising displaying the historical events in sequential order in response to user input.

12. The method of claim 9, further comprising displaying the historical events in response to selection of the unload button.

13. The method of claim 9, further comprising displaying at least one detailed error code, the detailed error code associated with at least one of the displayed historical events.

14. The method of claim 13, further comprising displaying a predetermined pattern interposed between at least one of the historical events and the at least one detailed error code.

15. The method of claim 9, wherein the information is displayed via a plurality of indicia disposed with the front panel portion.

16. The method of claim 9, wherein the indicia include light emitting diodes.

17. A computer-readable medium encoded with computer program instructions for extracting historical event information, the program instructions for:
addressing a plurality of indicia to display information associated with at least two historical events related to a media drive, wherein the information is displayed in a binary format and the plurality of indicia are associated with a front panel portion of the media drive.

18. The computer program product of claim 17, further comprising program instructions for displaying the historical events in sequential order.

19. The computer program product of claim 17, further comprising program instructions for displaying the historical events in sequential order in response to user input.

20. The computer program product of claim 17, further comprising program instructions for displaying the historical events in response to selection of the unload button.

21. The computer program product of claim 17, further comprising program instructions for displaying at least one detailed error code, the detailed error code associated with at least one of the displayed historical events.

22. The computer program product of claim 21, further comprising program instructions for displaying a predetermined pattern interposed between at least one of the historical events and the at least one detailed error code.
